(19) United States
(12) Patent Application Publication
(10) Pub. No.: US 2021/0078754 A1
(43) Pub. Date: Mar. 18, 2021

(54) CONTAINER FOR FOOD PRODUCTS

(71) Applicant: AMOR DI COTTO S.R.L., Milano (IT)

(72) Inventor: Alessandro ROSI, Parma (IT)

(21) Appl. No.: 16/998,543

(22) Filed: Aug. 20, 2020

(30) Foreign Application Priority Data
Sep. 18, 2019 (IT) 202019000003182

(51) Int. Cl. B65D 1/36; B65D 85/34

(52) U.S. Cl. CPC B65D 1/36; B65D 2543/00296; B65D 85/34

(57) ABSTRACT

A container for food products, including a substantially box-like body made of a recyclable and/or bio-compostable cellulose-based material, having an inner surface adapted for contact with foods, wherein said box-like body has a bottom wall and perimeter side walls connected to each other and to said bottom wall so as to define a containment volume for food products facing the inner surface and open above at an upper opening; wherein said bottom wall has at least one deformed zone defining a relief protruding from the inner surface for the retention of said food product; and wherein each perimeter side wall comprises at least one deformed zone defining a reinforcing rib of the side wall itself.

This application claims priority to Italian Patent Application 202019000003182 filed Sep. 18, 2019, the entirety of which is incorporated by reference herein.

The present invention relates to a container for food products. In particular, the invention relates to a container made in the form of a tray for containing sliced food products, such as already portioned cured meats or cheeses.

Food containers of different shapes and sizes are known, which are also adapted to contain different types of food products.

The containers for sliced products, generally called “trays”, are mostly made of plastic material and obtained in accordance with two different packaging methods.

A first method is thermoforming packaging, in which the food product is sliced very quickly and the container (in the form of a tray or envelope) is formed directly on the production line. In this case, the plastic films are unwound by coils and thermoformed to obtain the required shape and the sliced product automatically arranged in the tray thus formed.

A second method is packaging in a “closing machine”, where the product is sliced more slowly and the slices are arranged by hand in trays which are preformed separately from the slicing line. In this case the trays have their own shape and are die-cut at the respective manufacturer.

Although trays made of plastic material are very versatile and capable of obtaining different formats and sizes, however, they present a major drawback of an environmental nature, derived precisely from the non-degradable nature of the plastic itself.

Containers made at least in part with biodegradable material are therefore made available but can only be obtained by means of the first packaging method described above where the material layers are formed in-line.

In this case, in fact, the container obtained has a more “envelope-like” structure, as the flexible nature of the cellulose-based material does not allow to obtain the necessary structural rigidity typical of plastic trays.

However, the second method of packaging in “closing machines” has the advantage of keeping the quality of the food products intact and enhancing the freshness thereof, being sliced at higher temperatures and being arranged more slowly by hand.

For this reason, high-quality food products are mostly packaged only in preformed plastic trays, resulting in disadvantages in terms of plastic consumption and environmental protection.

The technical task of the present invention is therefore to provide a container for food products which is able to overcome the drawbacks arising from the prior art.

In particular, an object of the present invention is to provide a food container which is highly environmentally friendly and at the same time of high quality.

More precisely, an object of the present invention is to provide a container which is environmentally friendly and at the same time adapted to be made in accordance with the closing machine packaging methodology and therefore separate from the packaging line of the final product.

A further object of the present invention is to provide a container for food products which is fully recyclable and structurally capable of maintaining a typical “tray” shape.

Said objects are achieved by a container for food products having the features described in one or more of claims 1 to 9.

In particular, the container comprises a substantially box-like body made of a recyclable and/or bio-compostable cellulose-based material, having an inner surface adapted for contact with foods. The box-like body has a bottom wall and perimeter side walls (4) connected to each other and to said bottom wall so as to define a containment volume for food products facing the inner surface and opened above at an upper opening.

Preferably, the bottom wall has at least one deformed zone defining a relief protruding from the inner surface for the retention of the food product. Thus, even during the transport of the packaging, the product does not slide on the aforementioned inner surface.

Furthermore, each perimeter side wall comprises at least one deformed zone defining a reinforcing rib of the side wall itself capable of supporting the box-like structure of the container.

Preferably, the container further comprises a cover element coupled to said inner surface at an end edge of each side wall to close the upper opening and delimit the containment volume.

The cover element is defined by a sheet of plastic material having a peripheral annular zone associated at least partially with a flat tab in order to be manually removed from the body.

The presence of reliefs and ribs makes the container particularly attractive for the containment and marketing of fresh products such as sliced meat, thanks to the gas-resistant nature of the material used and of the plastic sheet.

These and other features with the related technical advantages, will become more apparent from the following exemplary, therefore non-limiting, description of a preferred, therefore not exclusive, embodiment of a container for food products as shown in the following figures, in which:

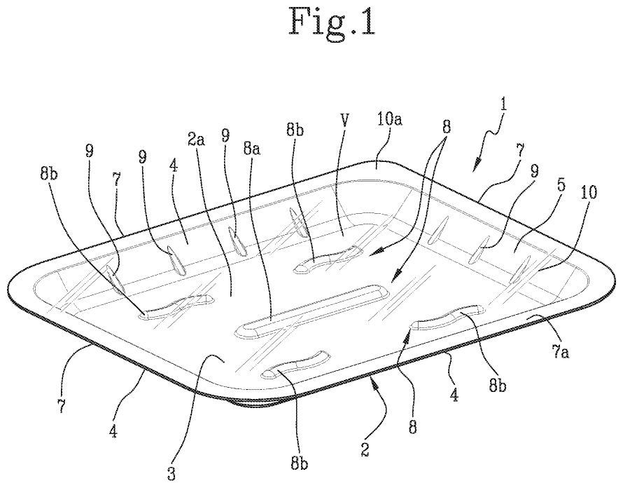

FIG. 1 is a top perspective view of a container for food products according to the present invention;

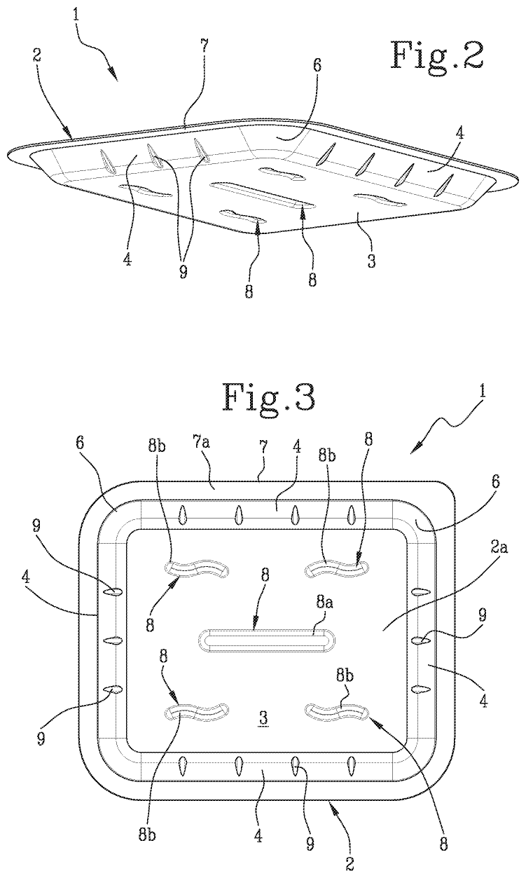

FIG. 2 is a bottom perspective view of the container for food products of FIG. 1; and

FIG. 3 is a top plan view of the container for food products of FIG. 1.

With reference to the appended figures, reference number 1 globally indicates a container for food products according to the present invention.

The container 1 finds advantageous application in the packaging of sliced products, such as in particular cured meats, ham or other charcuterie. However, the invention can be used for other types of food, always preferably sliced, such as cheese or other ready-to-eat products.

The container 1 comprising a substantially box-like body 2, made of a recyclable and/or bio-compostable cellulose-based material.

Advantageously, as clearly illustrated in the appended figures, the body 2 has a “tray” shape.

Preferably, the material used is a material predominantly made of paper, therefore totally recyclable and/or bio-compostable, and certified with international standards which guarantee proper forest management and traceability (for example FSC certification).

The body has an inner surface 2a suitable for contact with foods and therefore able to not alter the organoleptic characteristics of the food product and at the same time not subject to damage caused by the moisture produced by the food.

The box-like body 2 has a bottom wall 3 and perimeter side walls 4 connected to each other and emerging from the bottom wall 3.

In this way, a containment volume V of the food is defined internally, facing the inner surface 2a and open above at an upper opening 5.

In accordance with a preferred but non-limiting embodiment of the present invention, the bottom wall 3 has a rectangular peripheral extension in which four side walls 4 extend from the respective four sides. It should also be noted that the side walls 4 and the bottom wall 3 are made in a single piece and suitably connected. At the corners of the rectangular profile, the walls 4 are seamlessly joined by a connecting zone 6.

Each side wall 4 extends from the bottom wall 3 and along a direction transverse to the lying plane of the bottom wall 3 itself. In this situation, the side walls 4 are flared and converging towards the bottom wall 3.

Preferably, the side walls 4 have end edges defining a tab 7 extending along the entire perimeter of the box-like body 2. The tab 7 has an annular shape and has a contact surface 7a lying along a plane parallel to the lying plane of the bottom wall 3.

Advantageously, the bottom wall 3 has at least one deformed zone defining a relief 8 protruding from the inner surface 2a and adapted to retain the food product (not illustrated, as it is not part of the present invention).

In more detail, the bottom wall 3 has at least one first protruding relief 8a arranged in the centre of the bottom wall 3 and a plurality of second protruding reliefs 8b distributed on the periphery of the bottom wall 3.

The reliefs 8, which constitute bumps on the bottom wall 8, allow to retain the food product by binding it to the inner surface 2a and thus preventing the product itself from slipping on the surface. Advantageously, the reliefs 8 always ensure the correct positioning of the sliced product inside the container 1.

In particular, the first relief 8a extends along a linear section parallel to the larger sides of the rectangular extension of the bottom wall 3.

The second reliefs 8b instead extend along respective substantially “S-like” sections arranged at the corners of the rectangular extension.

In this situation, therefore, four second reliefs 8b are appropriately aligned with each other. However, it should be considered that the number and the shape of the reliefs 8 can be different according to the dimensions, the type of food product to be contained, and the specific aesthetic needs which the container 2 must have.

The container 2 also has at least one deformed zone defining a reinforcing rib 9 of the side wall 4.

More in particular, each perimeter side wall 4 comprises a plurality of reinforcing ribs 9 extending from the bottom wall 3 towards the aforementioned tab 7.

Also in this case, the number of reinforcing ribs 9, which also constitute bumps on the material, can be any according to the dimensions of the container 1 and the specific aesthetic needs.

In particular, each reinforcing rib 9 defines a convex portion at the inner surface 2a and extends on the portion of the side wall 4 closest to the bottom wall in order to give greater structural rigidity to the walls 4 themselves.

For this purpose, each rib 9 has increasing cross-sectional dimensions approaching the bottom wall 3 and has a substantially “drop-like” shape, i.e., provided with a narrow apex and an enlarged lower portion.

This particular shape ensures, as described above, the structural stability of the side wall and thus the typical tray-shaped form of the container 1.

In other words, the ribs 9 support a depth thickness known as a “breakout” which allows to have an appearance of a container tray and not simply an almost “flat” envelope, as occurs in the paper trays also used for thermoforming lines.

In this situation, the ribs 9 allow the paper structure to “withstand” the breakout necessary for an adequate depth while at the same time maintaining the shape and structure of the tray.

Finally, the container 1 comprises a cover element 10 (visible in FIG. 1) coupled to the inner surface 2a at the end edge of the side walls 4.

The element 10 allows to close the upper opening 5 and thus delimit the containment volume V to ensure the correct storage of the food products contained.

Preferably, the cover element 10 is defined by a sheet of plastic material having a peripheral annular zone at least partially associated with the contact surface 7a of the tab 7. This cover element 10 is therefore recycled as plastic, unlike the entire body 2.

Further provided is at least one gripping portion 10a detached from the contact surface 7a and configured to be grasped by a user who proceeds to remove the plastic sheet from the box-like body 2.

In this way, the cover element 10 allows to keep the modified atmosphere intact, that is, the oxygen combination which allows the longevity and preservability of the sliced product. Furthermore, the plastic sheet which closes the opening 5 is “peelable” and therefore makes it possible for the consumer to easily open it.

Preferably, the sheet is associated with the contact surface 7a by known thermal sealing systems.

Advantageously, the container 1 described above overcomes the drawbacks of the prior art and provides significant advantages.

It should first be noted that the cover element 10 made of plastic only marginally affects the entire container mainly made of paper. According to current regulations, the body 2 is therefore recyclable as paper while only the cover element 10 is recycled as plastic.

In addition, the container 1 described above comprises a plurality of inventive and independent features, which make it robust even though it is made of paper.

In fact, the characteristics of the invention allow to provide a container made of mainly cellulosic material which is comparable to the current plastic containers both for performance (strength and sealing) and for shape, thus favouring use in the various closing machine packaging methods.

1. A container for food products, comprising a substantially box-like body made of a recyclable and/or bio-compostable cellulose-based material, having an inner surface adapted for contact with foods,
wherein said box-like body has a bottom wall and perimeter side walls connected to each other and to said bottom wall so as to define a containment volume for food products facing the inner surface and open above at an upper opening;
wherein said bottom wall has at least one deformed zone defining a relief protruding from the inner surface for the retention of said food product;
and wherein each perimeter side wall comprises at least one deformed zone defining a reinforcing rib of the side wall itself;
said container comprising a cover element coupled to said inner surface at an end edge of each side wall to close the upper opening and delimit the containment volume.

2. The container according to claim 1, wherein the end edges of the side walls define a tab extending along the entire perimeter of the box-like body and having a contact surface lying along a plane parallel to the lying plane of the bottom wall.

3. The container according to claim 2, wherein said cover element is defined by a sheet of plastic material having a peripheral annular zone at least partially associated with said contact surface of the tab.

4. The container according to claim 3, wherein said annular zone has at least one gripping portion detached from the contact surface and configured to be grasped and define a condition in which the sheet is removed from the contact surface.

5. The container according to claim 1, wherein said body has a tray shape; said bottom wall having a rectangular peripheral extension and having four sides from which respective side walls extend; each side wall emerging from the bottom wall along a direction transverse to the lying plane of the bottom wall itself.

6. The container according to claim 5, wherein each perimeter side wall comprises a plurality of reinforcing ribs extending from the bottom wall towards the end edge; each rib having increasing cross-sectional dimensions approaching the bottom wall.

7. The container according to claim 6, wherein each reinforcing rib defines a convex portion at the inner surface.

8. The container according to claim 1, wherein said bottom wall has at least one first protruding relief arranged in the centre of the bottom wall and a plurality of second protruding reliefs distributed on the periphery of the bottom wall.

9. The container according to claim 8, wherein the first relief extends along a linear section parallel to the larger sides of the rectangular extension of the bottom wall; and wherein the second reliefs extend along respective substantially “S” sections arranged at the angles of said rectangular extension.
